(19) United States
(12) Patent Application Publication
(10) Pub. No.: US 2020/0302543 A1
(43) Pub. Date: Sep. 24, 2020

(54) METHOD AND SYSTEM FOR DETERMINING IF EQUIPMENT IS AT RISK AT AN INCIDENT SCENE

(71) Applicant: MOTOROLA SOLUTIONS, INC, CHICAGO, IL (US)

(72) Inventors: JESUS F. CORRETJER, WESTON, FL (US); DAVID KLEIN, PARKLAND, FL (US); STUART S. KREITZER, LAUD BY SEA, FL (US)

(21) Appl. No.: 16/359,133

(22) Filed: Mar. 20, 2019

(51) Int. Cl. G06Q 40/08; G06F 21/62

(52) U.S. Cl. CPC G06Q 40/08; G06F 21/6245

(57) ABSTRACT

A method and system provide a way of determining if equipment is at risk at an incident scene. A call is received about a new incident. The new incident includes an incident type, an incident location, and an incident severity. It is then determined that insured equipment is located at the incident location. An incident report is generated. The incident report includes a list of at-risk equipment at the incident location. A property owner of the at-risk equipment at the incident location is then alerted.

### BACKGROUND OF THE INVENTION

Companies, government agencies, and individuals purchase equipment that can be used for personal or commercial purposes. This potentially high value equipment is used or stored at particular locations. Oftentimes there are asset managers who have an interest in the equipment. These asset managers can include asset owners, insurance agents, insurance appraisers, and equipment repair and recovery services associated with lenders who have loaned money to purchase the equipment or insurance companies who are insuring the equipment.

There are times when incidents occur that can damage or put at risk buildings and the equipment located therein. Some incidents are naturally-occurring, such as floods, hurricanes, and earthquakes. Other incidents are man-caused, such as crime scenes, while other incidents are a combination of naturally-occurring incidents and crime scenes, such as looting that occur after an earthquake or during a power outage.

When incidents occur, public safety agencies become involved. They are alerted to the incident, for example by calls to a 9-1-1 center or by automated systems that become aware of the incident.

Unfortunately, the owners and others with interest in the equipment are not aware of the incidents until after they are resolved. By this point, the equipment may be damaged and the owners may have lost significant value in their equipment.

Therefore, a need exists for a method and system to help owners and those with an interest in equipment to minimize or mitigate the damage done to equipment that they have an interest in when an incident occurs at the location where the equipment is kept.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 depicts a system diagram of a communication system in accordance with an exemplary embodiment of the present invention.

FIG. 2 depicts a system diagram of a Geographic Information System (GIS) Mapping Solution in accordance with an exemplary embodiment of the present invention.

FIG. 3 depicts a flowchart in accordance with an exemplary embodiment of the present invention.

FIG. 4 depicts a flowchart in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

An exemplary embodiment provides a two-step process to register assets and a process to manage when an alert is raised relating to the registered assets. In an exemplary embodiment, an insurance company or re-insurer registers property and associates a location of the property with a public safety agency or organization representing public safety services. The location can be a specified address or site. In addition, the registration of the property also includes key parameters relating to the registered property. The key parameters can be, as an example, identification elements, possible incident parameters that impact the asset, or contact and response requirements. The identification elements can be, for example, the model number or serial number of the equipment. The incident parameters that impact the asset can be, for example, types of calls that could lead to a response on the part of the insurance company. The contact and response requirements can include, for example, the type of equipment needed to handle the property, such as a forklift or specialty chemical management equipment or materials.

In accordance with an exemplary embodiment, when an incident occurs, the dispatch system identifies the assets at the location impacted by the incident and triggers a communication to an insurance company to alert them of the incident. The insurance team will access a set of engagement rules that define staging parameters to let them know when and how they can engage the incident area. Associated insurance companies could leverage relevant, timely and actionable information to define response requirements regarding their insured assets to allow prompt action to salvage or mitigate further damage to their assets.

Thereby, insurance perils and insured assets are monitored, potential perils to insured assets are assessed against emergency activities, possible actions are determined, and selected actions are executed involving actors such as the emergency agency, policyholder, insurance agent, mitigation responder, and insurance appraiser.

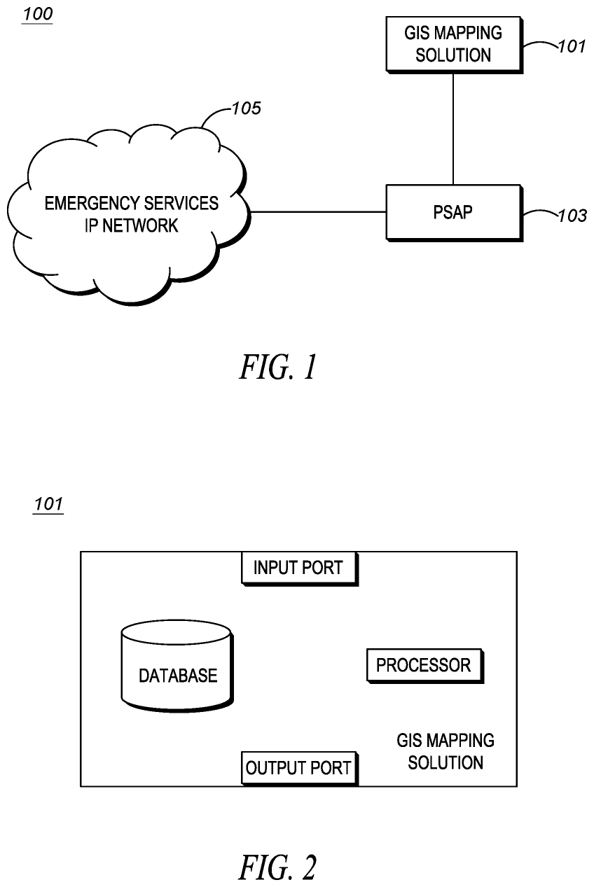

FIG. 1 depicts a system diagram of a communication system 100 in accordance with an exemplary embodiment of the present invention. Communication system 100 preferably includes a GIS Mapping Solution 101, a Public Safety Answering Point (PSAP) 103, and a Emergency Services IP Network 105.

GIS Mapping Solution 101 is a server or the like that is designed to capture, store, manipulate, analyze, manage, and present spatial or geographic data. In accordance with an exemplary embodiment, GIS Mapping Solution 101 is a solution that is used in public safety applications to process and store geographic information pertaining to an incident. GIS Mapping Solution 101 is depicted in more detail in FIG. 2.

PSAP 103 is a call center responsible for answering calls to an emergency telephone number for police, firefighting, and ambulance services. In accordance with an exemplary embodiment, trained dispatchers receive emergency calls and dispatch emergency services and personnel to an incident scene. PSAP 103 is preferably coupled to GIS Mapping Solution 101 and Emergency Services IP Network 105.

In accordance with an exemplary embodiment, PSAP 103 is a legacy PSAP. In this exemplary embodiment, there is an individual registration for each insured asset, preferably using a predetermined asset profile format.

In accordance with a further exemplary embodiment, PSAP 103 is a Next Generation (NG) 911-enabled PSAP. In this exemplary embodiment, an IoT master hub/node has access to the “smart” asset inventory and associated metadata and is registered in the GIS mapping database. It should be understood that communication system 100 can include multiple PSAPs, which can be all of the same type or can include a mixture of legacy and next generation PSAPs.

Emergency Services IP Network 105 includes an Emergency Call Routing Function (ECRF), an Emergency Services Routing Proxy (ESRP), a Subscriber Database, a Border Control Function (BCF), and a Local Information Server (LIS). In an exemplary embodiment, Emergency Services IP Network 105 includes a gateway for connecting to Legacy Communication Networks. For clarity purposes, these elements are not depicted in FIG. 1. In an exemplary embodiment, Emergency Services IP Network 105 physically resides in city infrastructure, but alternately can exist in a remote cloud server, or parts of Emergency Services IP Network 105 could be farmed out to third parties that provide analysis engines, Artificial Intelligence, and other functionality.

The ECRF routes emergency calls, such as 9-1-1 calls, to the appropriate PSAP, preferably based on the caller's location.

The ESRP is a SIP-based proxy server for location based call routing in Emergency Services IP Network 105. The ESRP provides call routing for legacy and next generation PSAPs, and preferably integrates with PSAPs for policy-based routing.

Subscriber Database is a database that stores information pertaining to subscribers to within communication system 100.

The BCF provides a secure entry into Emergency Services IP Network 105 for emergency calls. The BCF preferably includes firewall and admission control functionality, and may include anchoring of session and media as well as other security mechanisms to prevent deliberate or malicious attacks on PSAPs or other entities connected to Emergency Services IP Network 105. The BCF preferably connects to Telematics and Telemetrics devices, Wireless Carrier Networks, and Internet Service Providers.

The LIS is a network node that addresses the intermediate solution for providing e911 service for users of VoIP telephony. The LIS is the node that determines the location of the VoIP terminal. The LIS is also capable of providing location information to any IP device within its served access network.

FIG. 2 depicts GIS Mapping Solution 101 in accordance with an exemplary embodiment of the present invention. GIS Mapping Solution 101 preferably includes input port 201, output port 202, processor 203, and database 204.

Input port 201 receives electronic signals from one or more wired or wireless communication networks, from PSAP 103, or from a communication device.

Output port 202 transmits signals to PSAP 103, although it should be understood that output port 202 can be operably coupled to multiple PSAPs. In accordance with an exemplary embodiment, the output transmitted via output port 202 is a PDF file, but can a file of any suitable type, including but not limited to formats such as Adobe Flash, Scalable Vector Graphics (SVG), HTML, Image, WMS (Web Map Service), Web Feature Service (WFS), Web Coverage Service (WCS).

Although depicted in FIG. 2 as two separate elements, input port 201 and output port 202 can be a single element, such as a transceiver that could be an LTE modem, an FM transceiver, or a Wi-Fi or Ethernet transceiver

Processor 203 triggers methods to alert asset owners of an incident that may have an impact on their equipment. Processor 203 includes Web Services. Processor 203 may include a microprocessor, application-specific integrated circuit (ASIC), field-programmable gate array, or another suitable electronic device. Processor 203 obtains and provides information, for example, from input port 201, database 204, or to output port 202, and processes the information by executing one or more software instructions or modules, capable of being stored, for example, in a random access memory (“RAM”) area of database 204 or a read only memory (“ROM”) of database 204 or another non-transitory computer readable medium (not shown). The software can include firmware, one or more applications, program data, filters, rules, one or more program modules, and other executable instructions. Processor 203 is configured to retrieve from database 204 and execute, among other things, software related to the control processes and methods described herein.

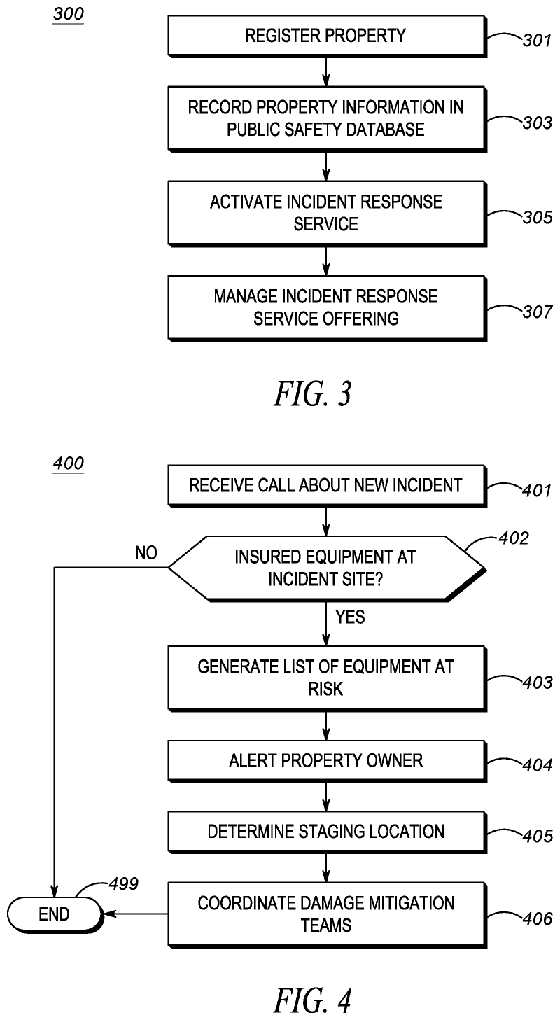

Database 204 can include one or more non-transitory computer-readable media, and may include a program storage area and a data storage area. The program storage area and the data storage area can include combinations of different types of memory, as described herein. In the embodiment illustrated, database 204 stores, among other things, instructions for the processor to carry out the methods of FIG. 3 and FIG. 4. In accordance with an exemplary embodiment, asset registration information is stored in database 204 in standard GIS database storage to ensure simple searching. The coupling to PSAP networks allows integration of asset data with standard public safety operating procedure for incident scene establishment and response activities.

FIG. 3 depicts a flowchart 300 in accordance with an exemplary embodiment of the present invention. In accordance with an exemplary embodiment, an entity with an interest in equipment, such as an owner or insurance company, registers the equipment in a public safety agency database, commonly referred to as an Asset Profile Database (APD), located in GIS Mapping Solution 101.

An insurance company or re-insurer registers (301) property with a municipality or the like. In accordance with an exemplary embodiment, property is registered and has associated information associated with each piece of property registered. In an exemplary embodiment, the associated information includes a location of the property, identification information of the property, requirements for engagement of the property, and triggering elements of the property. During subscription, insurance carriers preferably provide a profile for each insured asset. The profile preferably includes context information, such as contact information for the owner or insurance company, asset location, asset description, asset metadata, risk exposure factors (e.g., heat, cold, water, smoke, chemical, alive), engagement directives (e.g., preference of particular foam or water usage during a fire, impact due to high power gas fans, temperature ranges), mitigation response requirements (e.g., equipment, specialty chemicals) and staging parameters (e.g., size and access).

The location of the property preferably includes the address of the property, but can also include a site location of the property. The identification information of the property preferably includes a serial number of the equipment, but can also include a model number of the property. The requirements for engagement of the property relate to what steps are needed to stage, move, and/or store the property. Additional engagement rules can include directives to responding public safety agencies on what material or equipment they should use around the property to limit damage; including avoiding water, specific fire retardant foam, and direct exposure to high powered gas fans. On-scene incident telemetry can be shared to assist with appropriate response and recovery activities. The triggering elements of the property relate to specific Public Safety call types that trigger a communication with the insurance company. Examples of triggering elements include but are not limited to fire, smoke, water, chemical exposure, theft, weather event, lock down or an evacuation event. Examples of weather events include excessively cold temperatures, excessively hot temperatures, high winds, fire, and excessive rain, sleet, or snow.

In an alternate exemplary embodiment when using IoT enabled equipment, the insurance company registers an IoT Master Hub element. The registration allows access to IoT inventory and metadata, such as classification and risk exposure.

A municipality records (303) the property information in a public safety database, preferably by updating GIS Mapping Solution 101 with asset registration information. In accordance with an exemplary embodiment, public safety database 204 is under the control of the municipality and is a subscription database that insurance companies or others with an interest in equipment pay a fee to include their property information in the public safety database. Each record in the public safety database preferably includes an insurance carrier profile, a list of entries of equipment that the insurance carrier owns or has a financial interest in, a location of the equipment, and an incident type trigger field. In accordance with an exemplary embodiment, the recording of content into the database 204 includes elements that can be layered into standard PSAP/CAD mapping solutions.

The public safety agency activates (305) the Incident Response Service (IRS). The IRS preferably activates the subscription for emergency call query and response integration and manages the service offering from this point going forward.

The public safety agency manages (307) the IRS offering. In accordance with an exemplary embodiment, when an incident is reported to the public safety agency, such as when receiving an emergency call, the IRS determines if there is potential risk or damage to equipment that has a record stored in the public safety database.

FIG. 4 depicts a flowchart 400 in accordance with an exemplary embodiment of the present invention. In accordance with this exemplary embodiment, an incident is occurring and communication system 100 is determining if there is equipment at the incident scene, and if so alerting the property owner or insurance company of the incident, supplying incident details relevant to the status of the equipment, and also staging information for their equipment.

A public safety answering point (PSAP) or the like receives (401) a call about a new incident. In accordance with an exemplary embodiment, the dispatcher who receives the call notes the type, location, and severity of the incident. When the incident begins, the type of incident and severity are assessed by the system using inputs from possible pre-existing on-site sensors, connected first responder devices and regular intelligence from Public Safety (PS) personnel at the scene

The public safety system preferably determines if there is any insured equipment at the incident scene location. If there is not any insured equipment at the incident scene, the process ends (499).

If the public safety system determines at step 402 that there is insured equipment at the incident scene location, the public safety agency searches the subscription database 204 using the location of the incident to determine if any equipment that was registered by an owner or insurance or mitigation company is located at the incident location. The public safety agency preferably uses information from the insured asset profile database to make this determination. In an exemplary embodiment, processor 203 utilizes the type of incident, such as fire, hurricane, etc., to create a list of potential equipment at risk.

As one example, information from the asset profile database is used to determine content risk for the insurance company report, using factors such as specific asset location and risk exposure information. For example, some assets may be water-proof and thus immune to water damage from a flood or fire hose. Other equipment may be heat-resistant and not threatened by a building fire, and other equipment may be at a high enough location at an incident and not threatened by current water levels in a flood.

The public safety system generates (403) a list of equipment at risk at the location. The list is generated with preliminary information on insured content and the possible risk and damage, preferably based on a current incident assessment. In accordance with an exemplary embodiment, a sanitized description of the incident is produced by the public safety agency. The sanitized description is a full description of the incident information with any personal or confidential information removed. In addition, the public safety system preferably monitors the materials used by public safety personnel during the incident to determine if any of these materials match the asset risk exposure information.

In a first exemplary embodiment that does not include IoT devices, the risk/damage report is generated by the system. In a second exemplary embodiment that includes IoT devices, the risk/damage report is generated by the IoT hub.

The public safety system alerts (404) the property owner or insurance company of the at-risk equipment due to the incident. In an exemplary embodiment, the CAD of the public safety system alerts the asset owner with details regarding the equipment and incident, such as the items at risk, the location, and the incident type. The public safety system uses contact information obtained during database registration to alert the insurance company to the incident.

The public safety system determines (405) a location for staging. In accordance with an exemplary embodiment, the public safety system determines an area, preferably near enough to the incident scene so that moving equipment is not overly burdensome but far enough away that the equipment is in no risk of further damage and will not get in the way of efforts by public safety officers to work on the incident. The public safety system preferably uses database entries to determine staging parameters, such as the size needed for the staging area and the needed equipment for working on the equipment at the staging area. The public safety system sends information about a staging area for the insured equipment. The staging area is the area where insurance company employees can go to work on damaged or endangered equipment that is in a safe area relatively close to the incident area. In an exemplary embodiment, the information about the staging area includes the location of the staging area, access requirements to be admitted to the staging area, and engagement directions.

Once a staging area is established, the public safety system coordinates (406) the damage mitigation teams. In an exemplary embodiment, the damage mitigation teams are not allowed access to the staging area until the staging area is considered safe for non-public safety information personnel. When the staging area is clear for asset owners, the dispatcher or CAD alerts the damage mitigation teams to allow engagement. The damage mitigation teams facilitate recovery and damage mitigation of insured content impacted by the incident.

In accordance with an exemplary embodiment, while the public safety agency is managing the incident scene, the public safety system continues to update recovery and mitigation staging parameters and sharing the details with pertinent subscribers, such as owners and insurance companies. Updates at this stage can also include incident status with maps showing impacted area, location and impact assessment for each asset, such as damage type, on scene telemetry information, and damage extent. The damage type can be, for example, water, smoke, or chemical exposure. The damage extent can be, for example, the percentage of harm to the equipment. The system also considers impact to assets coming from materials used by public safety personnel working the scene, such as water, foam, or chemicals. On-scene public safety personnel and sensors can collect incident status telemetry details, such as temperature maps, activity telemetry, and resource utilization that can be shared with recovery and mitigation teams to update response requirements during an active incident.

In addition, incident scene management can range from stabilizing a life-threatening incident to determining when it is practical and efficient for mitigation responders to arrive at the incident scene to recover or mitigate damage to insured assets. Management of the scene preferably takes into account incident management efficiency from the standpoint of on-site multi-team coordination, for example between public safety and private teams, and also incident geographical characteristics, such as the amount of space available for a given number of people to work co-located.

In an exemplary embodiment, after completing step 404 the process detailed in FIG. 4 could return to step 402 to determine if any changes in the environment at the incident scene require additional checking for insured equipment at the incident scene, such as if a fire spreads to a new building. Additional incident telemetry information can be communicated to the insurance agency and/or recovery and mitigation teams to allow for near real time staging preparation activity adjustments.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for determining if equipment is at risk at an incident scene, the method comprising:
receiving, at a special purpose computer, a call about a new incident, the new incident comprising an incident type, an incident location, and an incident severity;
determining, at the special purpose computer, that insured equipment is located at the incident location;
generating, at the special purpose computer, an incident report, the incident report comprising a list of at-risk equipment at the incident location;
alerting, via the special purpose computer, a property owner of the list of at-risk equipment at the incident location; and
monitoring, by the special purpose computer, materials used by public safety personnel during the new incident to determine if any of the materials match an asset risk exposure information.

2. The method of claim 1, wherein the step of determining, at the special purpose computer, that insured equipment is located at the incident location comprises searching, by the special purpose computer, a subscription database using at least one of the incident location and the incident type to determine if any equipment that was registered in the subscription database is located at the incident location.

3. The method of claim 1, the method further comprising the step of redacting, using the special purpose computer, sensitive information from the incident report to generate a sanitized incident report.

4. (canceled)

5. The method of claim 1, wherein the step of alerting, via the special purpose computer, the property owner of the list of at-risk equipment at the incident location comprises alerting, via the special purpose computer, the property owner via a new incident report, the new incident report including details regarding the insured equipment, the new incident, the incident location, and the incident type.

6. The method of claim 1, the method further comprising the step of determining, by the special purpose computer, a staging location.

7. The method of claim 6, the method further comprising the step of transmitting, via the special purpose computer, the staging location to the property owner.

8. The method of claim 6, the method further comprising the step of determining, by the special purpose computer, access requirements for the staging location.

9. The method of claim 6, the method further comprising the step of coordinating, by the special purpose computer, damage mitigation teams at the staging location.

10. The method of claim 6, the method further comprising the steps of:
receiving, by the special purpose computer, telemetry data; and
refining, by the special purpose computer, staging parameters based on the telemetry data.

11. The method of claim 1, the method further comprising the steps of:
updating, by the special purpose computer, the incident report; and
alerting, via the special purpose computer, the property owner of the updated incident report.

12. The method of claim 1, wherein the new incident further comprises an impact assessment for the insured equipment.

13. The method of claim 12, wherein the impact assessment includes a damage type.

14. The method of claim 13, wherein the damage type is selected from the group consisting of water, smoke, chemical exposure, fire, temperature, and time length of damage exposure.

15. The method of claim 12, wherein the impact assessment comprises a damage extent of the equipment.

16. The method of claim 12, wherein the impact assessment comprises incident data telemetry compiled by public safety personnel used to refine mitigation response requirements.

17. A Geographic Information System (GIS) Mapping Solution comprising:
an input port configured to receive a call about a new incident, the new incident comprising an incident type, an incident location, and an incident severity;
a processor configured to:
determine that insured equipment is located at the incident location;
generate an incident report, the incident report comprising a list of at-risk equipment at the incident location; and
monitor materials used by public safety personnel during the new incident to determine if any of the materials match an asset risk exposure information; and
an output port configured to alerting a property owner of the list of at-risk equipment at the incident location.

18. The GIS Mapping Solution of claim 17, wherein the processor is further configured to determine a staging location.

19. The GIS Mapping Solution of claim 18, wherein the processor is further configured to:
receive telemetry data; and
refine staging parameters based on the telemetry data.

20. The GIS Mapping Solution of claim 17, wherein the new incident further comprises an impact assessment for the insured equipment, and wherein the impact assessment comprises incident data telemetry compiled by public safety personnel used to refine mitigation response requirements.
